(19) United States
(12) Patent Application Publication
(10) Pub. No.: US 2007/0229484 A1
(43) Pub. Date: Oct. 4, 2007

(54) Electro-optical device and electronic apparatus

(75) Inventors: Shin Fujita, Suwa-shi (JP); Shin Koide, Chino-shi (JP); Hiroko Muramatsu, Yokohama-shi (JP)

Correspondence Address: OLIFF & BERRIDGE, PLC, P.O. BOX 19928, ALEXANDRIA, VA, 22320, US

(73) Assignee: EPSON IMAGING DEVICES CORPORATION, AZUMINO-SHI (JP)

(21) Appl. No.: 11/710,403

(22) Filed: Feb. 26, 2007

(30) Foreign Application Priority Data
Mar. 17, 2006 (JP) 2006-074065

(51) Int. Cl. G09G 5/00

(52) U.S. Cl. 345/207

(57) ABSTRACT

An electro-optical device includes a substrate having a plurality of scanning lines, a plurality of data lines, and a plurality of pixels each including a pixel electrode and a switching element, the pixels disposed at positions corresponding to intersecting portions of the scanning lines and the data lines; a photoelectric transducer that converts light into electrical signals disposed on the substrate; and a reflecting layer that reflects incident light toward the photoelectric transducer and light-shielding layers that oppose the switching elements, the layers being disposed on the substrate. The reflecting layer is composed of the same film as the light-shielding layers.

### BACKGROUND

1. Technical Field

The present invention relates to electro-optical devices and electronic apparatuses.

2. Related Art

Electro-optical devices such as liquid-crystal displays (LCDs) are well known. Such electro-optical devices include, for example, a liquid-crystal panel and a backlight for supplying light to the liquid-crystal panel. The liquid-crystal panel includes a first substrate having a matrix of thin-film transistors (TFTs) serving as switching elements (described below), a second substrate that opposes the first substrate, and liquid crystal serving as an electro-optical substance interposed between the first and second substrates.

The first substrate includes a plurality of scanning lines disposed at predetermined intervals and a plurality of data lines disposed at predetermined intervals and crossing the scanning lines. Pixels are disposed at intersecting portions of the scanning lines and the data lines. Each pixel includes a TFT and a pixel electrode. A matrix of these pixels forms a display area. Gate electrodes, source electrodes, and drain electrodes of the TFTs are connected to the scanning lines, the data lines, and the pixel electrodes, respectively. The second substrate includes common electrodes that oppose the pixel electrodes.

The electro-optical device operates as follows. A selection voltage is line-sequentially supplied to the scanning lines such that all the pixels associated with predetermined scanning lines are selected. In synchronization with this selection of the pixels, image signals are supplied to the data lines. With this, the image signals are supplied to all the pixels selected using the selection voltage, and image data is written in the pixel electrodes.

When the image data is written in the pixel electrodes, driving voltages are applied to the liquid crystal according to potential differences between the pixel electrodes and the common electrodes. This changes the molecular alignment and order of the liquid crystal, and thus changes the amount of light emitted from the backlight and passing through the liquid crystal. In this manner, gray-scale images are produced.

The visibility of the display of the electro-optical device is changed according to the brightness of ambient light such as solar light reflecting off the surface of the electro-optical device. That is, as the surface of the electro-optical device becomes bright, the difference between the brightness of the display area of the electro-optical device and that of the surface of the electro-optical device becomes small. This causes a reduction in the visibility of the display of the electro-optical device.

To solve this problem, an electro-optical device including an optical sensor that detects the amount of ambient light has been proposed in, for example, JP-A-2005-121997. According to this technology, output to a backlight is controlled according to the amount of ambient light detected by the optical sensor. With this, the visibility of the display of the electro-optical device can be improved by adjusting the amount of light supplied from the backlight to the liquid-crystal panel according to the brightness of the surface of the electro-optical device.

The above-described optical sensor includes, for example, a positive-intrinsic-negative (PIN) diode serving as a photoelectric transducer that converts light into electrical signals. This PIN diode is formed on a semiconductor layer of a first substrate, the semiconductor layer including source regions and drain regions of TFTs formed thereon. However, in order to form a self-aligned lightly doped drain (LDD) structure, gate electrodes need to be formed on the semiconductor layer. On the other hand, in the area of the PIN diode, conductive masks (referred to as mask layer) composed of the same layer as that of the gate electrodes need to be formed on the layer having the gate electrodes in the intrinsic region (hereinafter referred to as I region) so as to prevent doping of impurities into the I region. Due to the mask layer formed in the I region, supply of ambient light to the I region is limited by the mask layer, resulting in insufficient photosensitivity. Therefore, removal of the mask layer in the area of the PIN diode is required for ensuring the supply of ambient light to the I region, thereby increasing the number of processing steps.

### SUMMARY

An advantage of some aspects of the invention is to provide an electro-optical device and an electronic apparatus capable of ensuring supply of ambient light to a photoelectric transducer and, at the same time, preventing an increase in the number of processing steps.

An electro-optical device according to one aspect of the invention includes a substrate having a plurality of scanning lines, a plurality of data lines, and a plurality of pixels each including a pixel electrode and a switching element, the pixels disposed at positions corresponding to intersecting portions of the scanning lines and the data lines; a photoelectric transducer that converts light into electrical signals disposed on the substrate; and a reflecting layer that reflects incident light toward the photoelectric transducer and light-shielding layers that oppose the switching elements, the layers being disposed on the substrate. The reflecting layer is composed of the same film as the light-shielding layers.

With this, incident ambient light can be reflected by the reflecting layer, and the supply of ambient light to the photoelectric transducer can be ensured.

Moreover, when a large amount of light is supplied to the switching elements, current leakage can occur and cause degradation of display quality. Therefore, the light-shielding layers are disposed on the substrate so as to oppose the switching elements. Since the reflecting layer and the light-shielding layers are composed of the same film and can be formed in one step, the reflecting layer does not cause an increase in the number of processing steps.

The reflecting layer is preferably composed of metal having low light absorptance.

With this, the amount of incident light reflected by the reflecting layer can be increased such that sufficient ambient light is supplied to the photoelectric transducer.

The photoelectric transducer is preferably disposed in an area on the substrate, the pixel electrodes being disposed in the area.

Ambient light is incident on the area in which the pixel electrodes are formed from outside the device. Thus, the supply of ambient light to the photoelectric transducer can be ensured more reliably.

The photoelectric transducer is preferably disposed in an area on the substrate other than the area in which the pixel electrodes are disposed.

With this, the supply of ambient light to the photoelectric transducer can be ensured without reducing aperture ratios of the pixels.

The electro-optical device preferably includes a light source that supplies light to the pixels; a determination circuit that determines that light is detected when the level of the electrical signals output from the photoelectric transducer exceeds a predetermined threshold value; and a control circuit that controls the amount of light supplied from the light source to the pixels on the basis of the determination by the determination circuit.

With this, the amount of light supplied from the light source can be controlled according to the brightness of the surface of the electro-optical device. Therefore, the visibility of the display of the electro-optical device can be improved regardless of the brightness of the surface of the electro-optical device by increasing the difference between the brightness in the display area of the electro-optical device and that of the surface of the electro-optical device.

According to another aspect of the invention, an electronic apparatus includes the above-described electro-optical device. This can produce the same effects as those described above.

According to yet another aspect of the invention, a method for manufacturing an electro-optical device including a substrate having a plurality of scanning lines, a plurality of data lines, and a plurality of pixels each including a pixel electrode and a switching element, the pixels being disposed at positions corresponding to intersecting portions of the scanning lines and the data lines, includes forming of a reflecting layer that reflects incident light toward a photoelectric transducer and light-shielding layers that oppose the switching elements on the substrate, the layers being composed of the same film; and forming of the photoelectric transducer that converts light into electrical signals on the reflecting layer. This can produce the same effects as those described above.

### BRIEF DESCRIPTION OF THE DRAWINGS

The invention will be described with reference to the accompanying drawings, wherein like numbers refer to like elements.

FIG. 1 is a block diagram illustrating the structure of an electro-optical device according to a first embodiment of the invention.

FIG. 2 is a circuit diagram illustrating the configurations of a photoelectric-conversion circuit and a determination circuit in the electro-optical device.

FIG. 3 is a partial cross-sectional view of a liquid-crystal panel in the electro-optical device.

FIG. 4 is a partial cross-sectional view of a first PIN diode in the electro-optical device.

FIG. 5 illustrates the photoelectric conversion efficiency of the photoelectric-conversion circuit in the electro-optical device.

FIG. 6 is a block diagram illustrating the structure of an electro-optical device according to a second embodiment of the invention.

FIG. 7 is a circuit diagram illustrating the configurations of a photoelectric-conversion circuit and a determination circuit in an electro-optical device according to a third embodiment of the invention.

FIG. 8 illustrates the output from the photoelectric-conversion circuit in the electro-optical device.

FIG. 9 is a perspective view illustrating the structure of a cellular phone to which the electro-optical device is applied.

### DESCRIPTION OF EXEMPLARY EMBODIMENTS

Embodiments of the invention will now be described with reference to the drawings. In the below-mentioned embodiments and modifications, the same reference numerals are used for the same components, and the description thereof will be omitted or simplified.

### First Embodiment

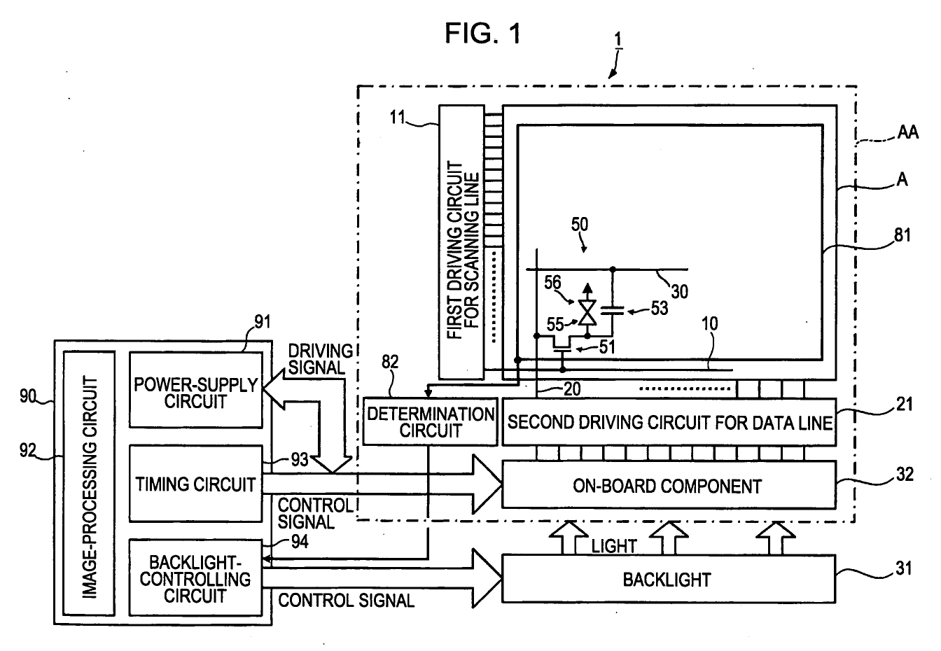

FIG. 1 is a block diagram illustrating the structure of an electro-optical device 1 according to a first embodiment of the invention. The electro-optical device 1 includes a liquid-crystal panel AA, an external driving circuit 90 that drives the liquid-crystal panel AA, and a backlight 31 serving as a light source. This electro-optical device 1 is of the transmissive type utilizing the light emitted from the backlight 31.

The liquid-crystal panel AA includes a display area A having a matrix of pixels 50. The display area A includes a photoelectric-conversion circuit 81 that converts supplied ambient light into electrical signals. A first driving circuit 11 for scanning lines and a second driving circuit 21 for data lines are disposed in the vicinity of the display area A. An on-board component 32 serving as an interface between the liquid-crystal panel AA and the external driving circuit 90 and a determination circuit 82 that determines that light is detected when the levels of the electrical signals output from the photoelectric-conversion circuit 81 exceed a predetermined threshold value are disposed in the vicinity of the second driving circuit 21.

The backlight 31 formed of, for example, cold cathode fluorescent lamps (CCFLs) or light-emitting diodes (LEDs) is disposed at the back surface of the liquid-crystal panel AA so as to supply light to the pixels 50 of the liquid-crystal panel AA.

The external driving circuit 90 includes a power-supply circuit 91 that supplies power to the liquid-crystal panel AA, an image-processing circuit 92 that supplies image signals to the liquid-crystal panel AA, a timing circuit 93 that outputs clock signals and start signals to the image-processing circuit 92 and the liquid-crystal panel AA, and a backlight-controlling circuit 94 that controls the amount of light supplied from the backlight 31 to the pixels 50.

The power-supply circuit 91 supplies driving signals to the liquid-crystal panel AA so as to drive the driving circuits 11 and 21.

The image-processing circuit 92 performs gamma correction on the input image data with consideration of the light-transmission characteristics of the liquid-crystal panel AA, and then generates image signals by digital-to-analog (D/A) conversion of the image data for each color. These image signals are supplied to the liquid-crystal panel AA.

The timing circuit 93 generates clock signals and start signals in synchronization with the image data input to the image-processing circuit 92, and supplies the signals to the driving circuits 11 and 21 on the liquid-crystal panel AA. Furthermore, the timing circuit 93 generates various timing signals, and outputs the signals to the image-processing circuit 92.

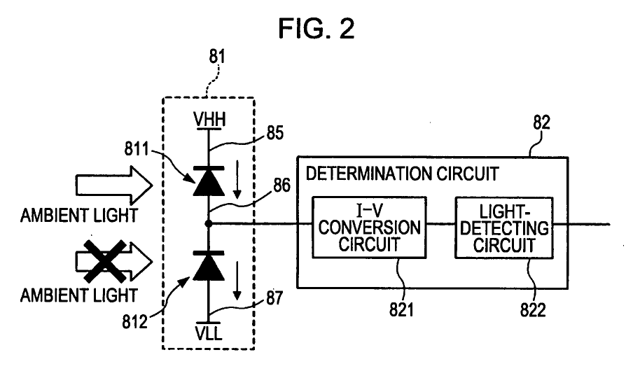

FIG. 2 is a circuit diagram illustrating the configurations of the photoelectric-conversion circuit 81 and the determination circuit 82. The photoelectric-conversion circuit 81 includes a first PIN diode 811 serving as a photoelectric transducer for converting ambient light that enters the liquid-crystal panel AA into electrical signals and a second PIN diode 812 serving as a photoelectric transducer that is shielded from the ambient light.

The output current of the photoelectric-conversion circuit 81 corresponds to a difference between the currents generated at the PIN diodes 811 and 812. More specifically, the cathode of the first PIN diode 811 is connected to a high-potential power source VHH via a wiring line 85, and the anode of the first PIN diode 811 is connected to the cathode of the second PIN diode 812 via a wiring line 86. The anode of the second PIN diode 812 is connected to a low-potential power source VLL via a wiring line 87. With this, a reverse bias voltage is applied to the first PIN diode 811 and the second PIN diode 812, and thus currents serving as electrical signals are generated. The current generated at the first PIN diode 811 is changed according to the ambient light and other factors such as the temperature of the PIN diode. On the other hand, the current generated at the second PIN diode 812 is changed according to factors such as the temperature of the PIN diode other than the ambient light since the ambient light is prevented from reaching the PIN diode. Therefore, the photoelectric-conversion circuit 81 can cancel the influences caused by the factors such as the temperatures of the PIN diodes other than the ambient light by determining the difference between the current generated at the first PIN diode 811 and that generated at the second PIN diode 812, and can output a current based on only the ambient light that is incident on the liquid-crystal panel AA.

The determination circuit 82 includes a current-to-voltage (I-V) conversion circuit 821 that converts current into voltage and a light-detecting circuit 822 that outputs light-detection signals (described below). The I-V conversion circuit 821 receives the current output from the photoelectric-conversion circuit 81. The I-V conversion circuit 821 converts the input current into voltage, and outputs the voltage to the light-detecting circuit 822. The light-detecting circuit 822 compares the input voltage with a predetermined reference voltage. When the level of the voltage output from the I-V conversion circuit 821 is higher than that of the predetermined reference voltage, the light-detecting circuit 822 determines that light is detected, and outputs a light-detection signal of an H level. On the other hand, when the level of the voltage output from the I-V conversion circuit 821 is lower than that of the predetermined reference voltage, the light-detecting circuit 822 determines that light is not detected, and outputs a light-detection signal of an L level.

With reference to FIG. 1, the backlight-controlling circuit 94 outputs signals for controlling brightness to the backlight 31 on the basis of the light-detection signals output from the determination circuit 82 so as to control the amount of light emitted by the backlight 31. More specifically, when the light-detection signals are at the H level, the backlight-controlling circuit 94 determines that the amount of ambient light is large, i.e., the apparatus is in bright light, and increases the amount of light emitted by the backlight 31. On the other hand, when the light-detection signals are at the L level, the backlight-controlling circuit 94 determines that the amount of ambient light is small, i.e., the apparatus is in low light, and reduces the amount of light emitted by the backlight 31.

The structure of the liquid-crystal panel AA will now be described. The liquid-crystal panel AA includes a plurality of scanning lines 10, a plurality of common lines 30, and a plurality of data lines 20 disposed at predetermined intervals and crossing the scanning lines 10 and the common lines 30. The pixels 50 are formed at intersecting portions of the scanning lines 10, the common lines 30, and the data lines 20.

The pixels 50 each include a transistor 51 serving as a switching element, a pixel electrode 55, a common electrode 56 opposing the pixel electrode 55, and a storage capacitor 53, one end of the storage capacitor 53 being connected to the pixel electrode 55 and the other end connected to the corresponding common line 30.

The gate electrodes of the transistors 51 are connected to the corresponding scanning lines 10, and the source electrodes of the transistors 51 are connected to the corresponding data lines 20. The drain electrodes of the transistors 51 are connected to the corresponding pixel electrodes 55 and the corresponding storage capacitors 53. Liquid crystal is retained between the pixel electrodes 55 and the common electrodes 56. Thus, the transistors 51 electrically connect the data lines 20 to the corresponding pixel electrodes 55 and the corresponding storage capacitors 53 when a selection voltage is applied from the scanning lines 10 to the transistors 51.

The first driving circuit 11 for the scanning lines line-sequentially supplies the selection voltage for bringing the transistors 51 into conduction to the scanning lines 10. For example, when the selection voltage is supplied to a scanning line 10, all the transistors 51 connected to this scanning line 10 become conductive, and all the pixels 50 associated with this scanning line 10 are selected. The second driving circuit 21 for the data lines supplies image signals to the data lines 20, and writes the image data in the pixel electrodes 55 of the pixels 50 via the electrically connected transistors 51.

The electro-optical device 1 operates as follows. The first driving circuit 11 line-sequentially supplies the selection voltage to the scanning lines 10 such that all the pixels 50 associated with the corresponding scanning lines 10 are selected. In synchronization with this selection of the pixels 50, image signals are supplied from the second driving circuit 21 to the data lines 20. With this, the image signals are supplied from the data lines 20 via the transistors 51 to all the pixels 50 selected by the first driving circuit 11, and image data is written in the pixel electrodes 55.

When the image data is written in the pixel electrodes 55, driving voltages are applied to the liquid crystal according to potential differences between the pixel electrodes 55 and the common electrodes 56. Changes in voltage of the image signals can change the molecular alignment and order of the liquid crystal, and thus can produce gray-scale images using light modulation of the pixels 50. The driving voltages applied to the liquid crystal are retained at the previous levels by the charges stored in the storage capacitors 53 for a period that is three orders of magnitude longer than the period for which the image data is written.

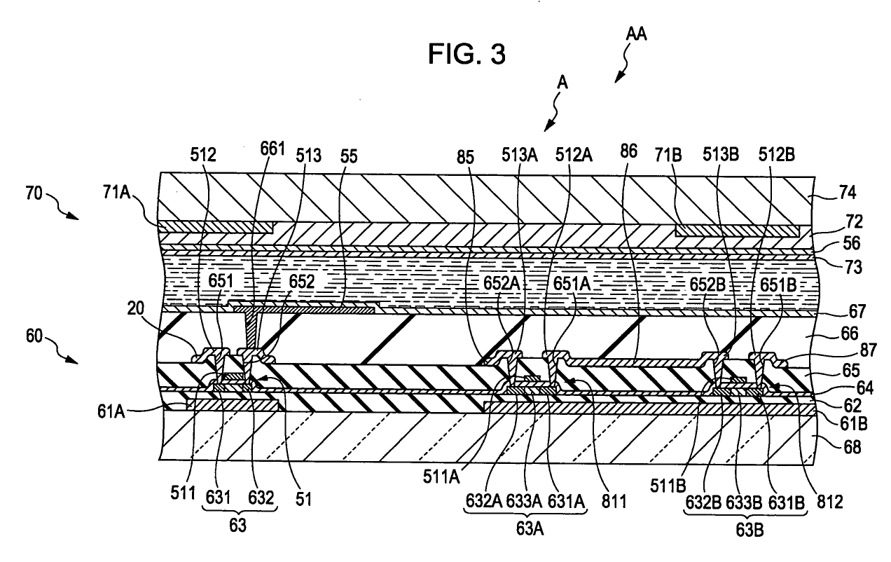

FIG. 3 is a partial cross-sectional view of the liquid-crystal panel AA. As shown in FIG. 3, the liquid-crystal panel AA includes a first substrate 60 having the above-described transistors 51 disposed thereon, a second substrate 70 that opposes the first substrate 60, and liquid crystal serving as an electro-optical substance interposed between the substrates 60 and 70.

The first substrate 60 includes a glass base 68 having an underlying insulating film (not shown) formed over the entire surface thereof. The transistors 51, the first PIN diode 811, and the second PIN diode 812 are formed on this first substrate 60.

First, an area having a transistor 51 on the first substrate 60 will be described. A light-shielding layer 61A composed of Ti, which has low light absorptance, is formed on the underlying insulating film in the area of the transistor 51, and an insulating interlayer 62 is formed on this light-shielding layer 61A.

A semiconductor layer 63 is formed on the insulating interlayer 62 so as to oppose the light-shielding layer 61A. A source region 631 and a drain region 632 are formed at either end of the semiconductor layer 63 using impurity doping. A gate electrode 511 is formed above the semiconductor layer 63 via an oxide film 64. This gate electrode 511 is connected to a scanning line 10.

The semiconductor layer 63 has the LDD structure, i.e., portions of the source region 631 and the drain region 632 adjacent to a channel region located below the gate electrode 511 have a relatively low impurity content.

The source region 631 and the drain region 632 are formed by doping impurities into the semiconductor layer 63 two times as follows. At the first impurity doping, impurities at a high concentration are doped into the whole area of the semiconductor layer 63 while a part of the semiconductor layer 63 is masked by the gate electrode 511. With this, the source region 631 and the drain region 632 are formed at either end of the semiconductor layer 63. At the second impurity doping, impurities at a low concentration are doped into portions of the semiconductor layer 63 adjacent to the channel region while the part of the semiconductor layer 63 is masked by the gate electrode 511. With this, portions having a low impurity content are formed.

An insulating interlayer 65 is formed on the gate electrode 511 and the oxide film 64. The oxide film 64 and the insulating interlayer 65 each have a contact hole 651 for connecting the source region 631 to a source electrode 512 and a contact hole 652 for connecting the drain region 632 to a drain electrode 513.

The source electrode 512 and the drain electrode 513 are formed on the insulating interlayer 65. The source electrode 512 is connected to a data line 20 formed on the insulating interlayer 65.

An insulating interlayer 66 is formed on the source electrode 512, the drain electrode 513, the data line 20, and the insulating interlayer 65. The insulating interlayer 66 has a contact hole 661 for connecting the drain electrode 513 to a pixel electrode 55. The pixel electrode 55 is formed on the insulating interlayer 66, and an alignment film 67 is formed on the insulating interlayer 66 and the pixel electrode 55.

Next, an area having the PIN diodes 811 and 812 on the first substrate 60 will be described. A reflecting layer 61B is formed on the underlying insulating film in the area of the PIN diodes 811 and 812 during the formation of the light-shielding layers 61A. Therefore, the reflecting layer 61B is the same as the light-shielding layers 61A, and is composed of Ti, the light absorptance of which is low. The insulating interlayer 62 is formed on the reflecting layer 61B.

Semiconductor layers 63A and 63B are formed on the insulating interlayer 62 so as to oppose the reflecting layer 61B during the formation of the semiconductor layers 63. These semiconductor layers 63A and 63B include P regions 631A and 631B having P-type impurities doped therein, N regions 632A and 632B having N-type impurities doped therein, and I regions 633A and 633B having no impurities doped therein, respectively. The P regions 631A and 631B correspond to anodes, and the N regions 632A and 632B correspond to cathodes. Conductive mask layers 511A and 511B are formed above the semiconductor layers 63A and 63B, respectively, via the oxide film 64 during the formation of the gate electrodes 511.

The P regions 631A and 631B, the N regions 632A and 632B, and the I regions 633A and 633B are formed during the formation of the source regions 631 and the drain regions 632 of the semiconductor layers 63. That is, the P regions 631A and 631B, the N regions 632A and 632B, and the I regions 633A and 633B are formed by doping impurities into the semiconductor layers 63A and 63B two times as follows.

At the first impurity doping, P-type impurities are doped into predetermined regions of the semiconductor layers 63A and 63B while parts of the semiconductor layers 63A and 63B are masked by the mask layers 511A and 511B, respectively. With this, the P regions 631A and 631B are formed in the semiconductor layers 63A and 63B, respectively. At the second impurity doping, N-type impurities are doped into regions of the semiconductor layers 63A and 63B other than the P regions 631A and 631B, respectively, while the parts of the semiconductor layers 63A and 63B are masked by the mask layers 511A and 511B, respectively. With this, the N regions 632A and 632B are formed in the semiconductor layers 63A and 63B, respectively.

In the above-described impurity doping performed two times, no impurities are doped into the regions of the semiconductor layers 63A and 63B masked by the mask layers 511A and 511B, respectively. Thus, the I regions 633A and 633B are formed in the semiconductor layers 63A and 63B at the regions masked by the mask layers 511A and 511B, respectively.

The insulating interlayer 65 is formed on the mask layers 511A and 511B and the oxide film 64. The oxide film 64 and the insulating interlayer 65 each have contact holes 651A and 651B for connecting the P regions 631A and 631B to anodes 512A and 512B, respectively, and contact holes 652A and 652B for connecting the N regions 632A and 632B to cathodes 513A and 513B, respectively.

The anodes 512A and 512B, the cathodes 513A and 513B, and the wiring lines 85 to 87 are formed on the insulating interlayer 65. The anode 512A of the first PIN diode 811 is connected to the cathode 513B of the second PIN diode 812 via the wiring line 86 formed on the insulating interlayer 65. The cathode 513A of the first PIN diode 811 is connected to the high-potential power source VHH via the wiring line 85. The anode 512B of the second PIN diode 812 is connected to the low-potential power source VLL via the wiring line 87.

The insulating interlayer 66 is formed on the anodes 512A and 512B, the cathodes 513A and 513B, the wiring lines 85 to 87, and the insulating interlayer 65. The alignment film 67 is formed on this insulating interlayer 66.

Next, the second substrate 70 will be described. The second substrate 70 includes a glass base 74 having light-shielding films 71A functioning as a black matrix formed thereon, the light-shielding films 71A disposed in spaces between adjacent pairs of pixels 50. Moreover, a light-shielding film 71B is formed on the glass base 74 so as to oppose the second PIN diode 812 during the formation of the light-shielding films 71A. Ambient light is prevented by this light-shielding film 71B.

A colored layer 72 serving as a color filter is formed on the glass base 74 and the light-shielding films 71A and 71B. The common electrodes 56 composed of a transparent conductive film such as indium tin oxide (ITO) and indium zinc oxide (IZO) are formed on the colored layer 72 so as to oppose the pixel electrodes 55. An alignment film 73 is formed on the common electrodes 56.

A liquid-crystal layer is disposed between the first substrate 60 and the second substrate 70, and is sealed by a seal (not shown) formed around the first substrate 60 and the second substrate 70.

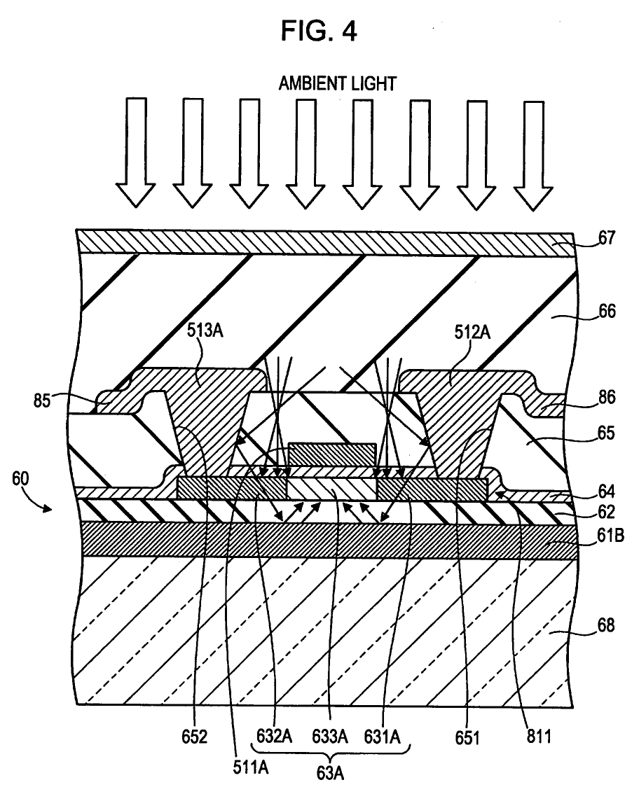

FIG. 4 is a partial cross-sectional view of the first PIN diode 811. Ambient light enters the second substrate 70 of the liquid-crystal panel AA shown in FIG. 3 and travels toward the first substrate 60. The ambient light incident on the first substrate 60 passes through the alignment film 67, the insulating interlayers 65 and 66, and the oxide film 64, and is directly supplied to the I region 633A of the first PIN diode 811. In addition, the ambient light reflected by the anode 512A, the cathode 513A, and the reflecting layer 61B is also supplied to the I region 633A of the first PIN diode 811.

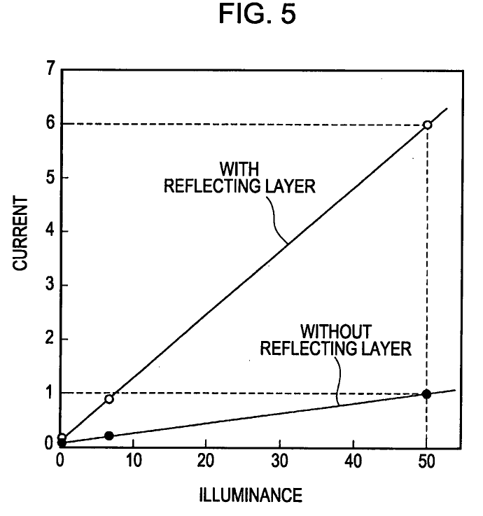

FIG. 5 illustrates the photoelectric conversion efficiency of the photoelectric-conversion circuit 81. FIG. 5 illustrates the relationship between the brightness of the surface of the electro-optical device 1 and the amount of current the received ambient light is converted into by the photoelectric-conversion circuit 81 with or without the reflecting layer 61B. For example, when the brightness of the surface of the electro-optical device 1 corresponds to an illuminance of 50, the amount of current generated by the photoelectric-conversion circuit 81 is 1 when no reflecting layer 61B is provided. On the other hand, the amount of current generated by the photoelectric-conversion circuit 81 is 6 when the reflecting layer 61B is provided.

This embodiment has the following effects. Due to the reflecting layer 61B that reflects the ambient light incident on the first substrate 60 toward the I region 633A of the first PIN diode 811, the supply of ambient light to the I region 633A of the first PIN diode 811 can be ensured.

The light-shielding layers 61A are formed on the first substrate 60 so as to oppose the transistors 51. This can prevent current leakage caused by a large amount of light supplied from the backlight 31, and can prevent degradation of display quality. Since the light-shielding layers 61A and reflecting layer 61B are composed of the same film and can be formed in one step, the reflecting layer 61B does not cause an increase in the number of processing steps.

The photoelectric-conversion circuit 81 including the first PIN diode 811 is disposed in the area having the pixel electrodes 55 on the first substrate 60, i.e., in the display area A. Since ambient light is directly incident on the display area A, the supply of the ambient light to the I region 633A of the first PIN diode 811 can be reliably ensured.

The electro-optical device 1 includes the backlight 31 that supplies light to the pixels 50, the determination circuit 82 that converts current output from the photoelectric-conversion circuit 81 including the PIN diodes 811 and 812 into voltage and determines that light is detected when the converted voltage is higher than the predetermined reference level, and the backlight-controlling circuit 94 that controls the amount of light supplied from the backlight 31 to the pixels 50 on the basis of the determination by the determination circuit 82. This allows the electro-optical device 1 to control the amount of light supplied by the backlight 31 according to the brightness of the surface of the electro-optical device 1. Thus, the visibility of the display of the electro-optical device 1 can be improved regardless of the brightness of the surface of the electro-optical device 1 by increasing the difference between the brightness in the display area A of the electro-optical device 1 and that of the surface of the electro-optical device 1.

### Second Embodiment

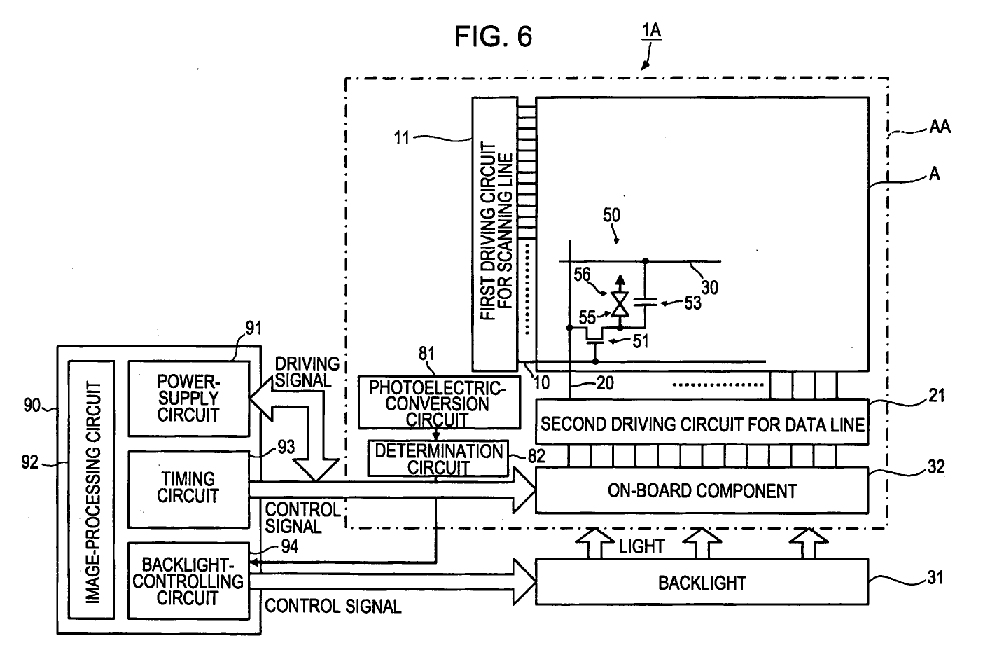

FIG. 6 is a block diagram illustrating the structure of an electro-optical device 1A according to a second embodiment of the invention. In this embodiment, the position of the photoelectric-conversion circuit 81 differs from that in the first embodiment. Structures other than this are the same as those in the first embodiment. The photoelectric-conversion circuit 81 is disposed in an area on the first substrate 60 other than that in which the pixel electrodes 55 are disposed, i.e., in an area other than the display area A in the liquid-crystal panel AA.

This embodiment has the following effects. Since the photoelectric-conversion circuit 81 including the first PIN diode 811 is disposed in the area other than that including the pixel electrodes 55 on the first substrate 60, the supply of the ambient light to the I region 633A of the first PIN diode 811 can be ensured without reducing aperture ratios of the pixels 50.

### Third Embodiment

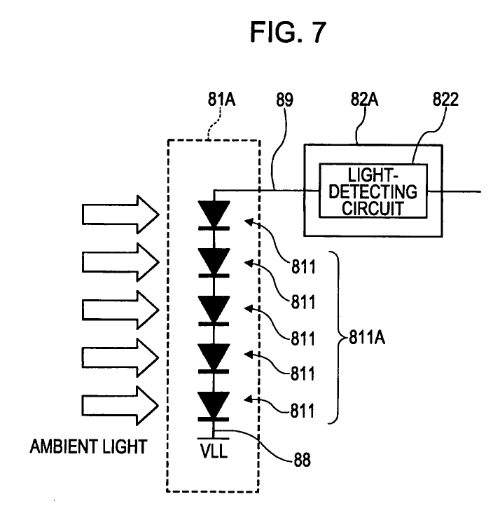

FIG. 7 is a circuit diagram illustrating the configurations of a photoelectric-conversion circuit 81A and a determination circuit 82A according to a third embodiment of the invention. In this embodiment, the configurations of the photoelectric-conversion circuit 81A and the determination circuit 82A differ from those in the first embodiment. Structures other than these are the same as those in the first embodiment.

The photoelectric-conversion circuit 81A includes five first PIN diodes 811. These five first PIN diodes 811 connected in series constitute a PIN-diode group 811A.

The output voltage of the photoelectric-conversion circuit 81A corresponds to the sum of the voltages generated at the five first PIN diodes 811. More specifically, a first end of the PIN-diode group 811A adjacent to the anode of the top first PIN diode 811 (in FIG. 7) is connected to the determination circuit 82A via a wiring line 89. Moreover, a second end of the PIN-diode group 811A adjacent to the cathode of the bottom first PIN diode 811 is connected to the low-potential power source VLL via a wiring line 88. With this, a forward bias voltage is applied to the first PIN diodes 811, and voltages serving as electrical signals are generated at the first PIN diodes 811. The voltages generated at the first PIN diodes 811 are changed according to the supply of ambient light. Therefore, the photoelectric-conversion circuit 81A sums the voltages generated at the five first PIN diodes 811, and outputs a voltage that is approximately five times as large as that generated at each one of the first PIN diodes 811 on the basis of the ambient light incident on the liquid-crystal panel AA.

The determination circuit 82A includes the light-detecting circuit 822 that outputs light-detection signals. The light-detecting circuit 822 receives the voltage output from the photoelectric-conversion circuit 81A.

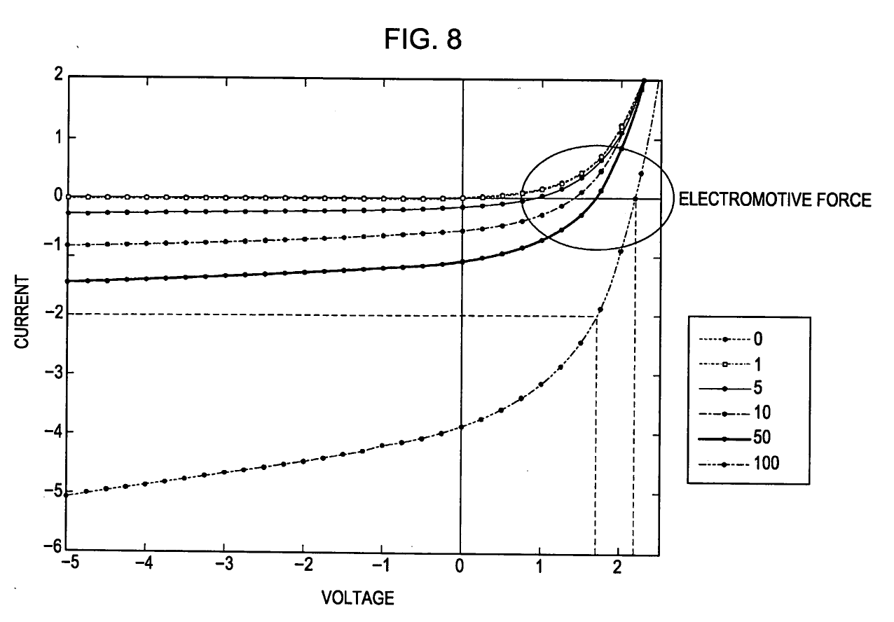

FIG. 8 illustrates the output from the photoelectric-conversion circuit 81A. More specifically, FIG. 8 illustrates the relationship between the current and the voltage of the photoelectric-conversion circuit 81A including the five first PIN diodes connected in series when the brightness of the surface of the electro-optical device corresponds to an illuminance of 0, 1, 5, 10, 50, or 100. For example, when the illuminance is 100, a voltage of approximately 2.2 serving as an electromotive force can be obtained. Moreover, a voltage of approximately 1.8 serving as an electromotive force can be obtained even when a current of −2 passes through the first PIN diodes 811. The five first PIN diodes 811, each one generating only a small voltage, are connected in series so as to ensure a sufficient voltage.

This embodiment has the following effects. The PIN-diode group 811A including the five first PIN diodes 811 connected in series is provided for the photoelectric-conversion circuit 81A, and the second end of the PIN-diode group 811A adjacent to the cathode of the bottom first PIN diode 811 is connected to the low-potential power source VLL via the wiring line 88. With this, each of the first PIN diodes 811 generates a voltage on the basis of the ambient light incident on the liquid-crystal panel AA, and the photoelectric-conversion circuit 81A outputs the total voltage. Therefore, the determination circuit 82A does not need to convert current into voltage. This can prevent errors in conversion, and can lead to more accurate determination of the ambient brightness.

### Modification

The invention is not limited to the above-described embodiments, and modifications and improvements are possible within the scope of the invention. For example, in the first embodiment, the electro-optical device 1 is of the transmissive type utilizing the light emitted from the backlight 31. However, the apparatus is not limited to this, and can be of the transflective type, which is a combination of the transmissive type and the reflective type that utilizes the incident ambient light. Similarly, the electro-optical device 1A in the second embodiment is of the transmissive type as in the electro-optical device 1 in the first embodiment. However, the apparatus is not limited to this, and can be of the transflective type or of the reflective type.

Moreover, for example, in the third embodiment, the photoelectric-conversion circuit 81A includes five first PIN diodes 811 connected in series. However, the invention is not limited to this, and the photoelectric-conversion circuit 81A can include ten first PIN diodes 811 connected in series.

Moreover, in the above-described embodiments, the determination circuits 82 and 82A are disposed in the liquid-crystal panel AA. However, the invention is not limited to this, and the determination circuits 82 and 82A can be provided for the external driving circuit 90.

Moreover, in the above-described embodiments, the invention is applied to the electro-optical devices 1 and 1A including liquid crystal serving as an electro-optical substance. However, the invention is not limited to this, and can also be applied to electro-optical devices including electro-optical substances other than liquid crystal. For example, the invention can be similarly applied to various electro-optical devices such as organic light-emitting display (OLED) panels including organic light-emitting diodes; electrophoretic display panels including microcapsules serving as electro-optical substances, the microcapsules being composed of colored liquid and white particles dispersed in the liquid; twisting-ball display panels including twisting balls serving as electro-optical substances, the twisting balls having colored regions whose colors differ in terms of polarity; toner display panels including black toner serving as an electro-optical substance; and plasma display panels including high-pressure gases such as helium and neon serving as electro-optical substances.

Moreover, the liquid crystal in the above-described embodiments can be of the twisted nematic (TN) type, or can be liquid crystal having a negative dielectric constant. Moreover, the display mode of the liquid crystal can be in-plane switching (IPS) or fringe-field switching (FFS).

### Application

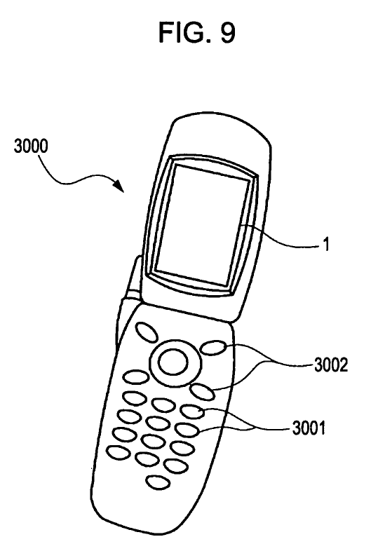

Next, an electronic apparatus including the electro-optical device 1 according to the above-described embodiments will be described. FIG. 9 is a perspective view illustrating the structure of a cellular phone to which the electro-optical device 1 is applied. A cellular phone 3000 includes a plurality of operation buttons 3001, a plurality of scroll buttons 3002, and the electro-optical device 1. Screen images displayed on the electro-optical device 1 are scrolled by the operation of the scroll buttons 3002.

In addition to that shown in FIG. 9, the electronic apparatuses to which the electro-optical device 1 can be applied include personal computers, personal digital assistants, digital still cameras, liquid-crystal televisions, videotape recorders of the direct viewfinder type, car navigation systems, pagers, electronic organizers, calculators, word processors, workstations, videophones, point-of-sale terminals, and apparatuses including touch panels. The above-described electro-optical devices can be used as displays for these various electronic apparatuses.

The entire disclosure of Japanese Patent Application No. 2006-074065, filed Mar. 17, 2006 is expressly incorporated by reference herein.

What is claimed is:

1. An electro-optical device comprising:
a substrate including a plurality of scanning lines, a plurality of data lines, and a plurality of pixels each including a pixel electrode and a switching element, the pixels disposed at positions corresponding to intersecting portions of the scanning lines and the data lines;
a photoelectric transducer that converts light into electrical signals disposed on the substrate; and
a reflecting layer that reflects incident light toward the photoelectric transducer and light-shielding layers that oppose the switching elements, the layers being disposed on the substrate, wherein
the reflecting layer is composed of the same film as the light-shielding layers.

2. The electro-optical device according to claim 1, wherein the reflecting layer is composed of metal having low light absorptance.

3. The electro-optical device according to claim 1, wherein the photoelectric transducer is disposed in an area on the substrate, the pixel electrodes being disposed in the area.

4. The electro-optical device according to claim 1, wherein the photoelectric transducer is disposed in an area on the substrate other than the area in which the pixel electrodes are disposed.

5. The electro-optical device according to claim 1, further comprising:
a light source that supplies light to the pixels;
a determination circuit that determines that light is detected when the level of the electrical signals output from the photoelectric transducer exceeds a predetermined threshold value; and
a control circuit that controls the amount of light supplied from the light source to the pixels on the basis of the determination by the determination circuit.

6. An electronic apparatus comprising the electro-optical device according to claim 1.

7. A method for manufacturing an electro-optical device including a substrate having a plurality of scanning lines, a plurality of data lines, and a plurality of pixels each including a pixel electrode and a switching element, the pixels being disposed at positions corresponding to intersecting portions of the scanning lines and the data lines, comprising:
forming of a reflecting layer that reflects incident light toward a photoelectric transducer and light-shielding layers that oppose the switching elements on the substrate, the layers being composed of the same film; and
forming of the photoelectric transducer that converts light into electrical signals on the reflecting layer.
